(19) United States
(12) Patent Application Publication
(10) Pub. No.: US 2024/0053273 A1
(43) Pub. Date: Feb. 15, 2024

(54) ESTIMATING A COEFFICIENT OF TRACTION

(71) Applicants: ZF FRIEDRICHSHAFEN AG, Friedrichshafen (DE); The Goodyear Tire & Rubber Company, Akron, OH (US)

(72) Inventors: Julian KING, Rankweil (AT); Ulrich MAIR, Friedrichshafen (DE); Yang WANG, Friedrichshafen (DE); Kanwar Bharat SINGH, Akron, OH (US); Sven SCHÄFER-OREILLY, Akron, OH (US)

(21) Appl. No.: 18/232,470

(22) Filed: Aug. 10, 2023

(30) Foreign Application Priority Data
Aug. 10, 2022 (DE) 102022208311.3

(51) Int. Cl. G01N 21/84; G01P 15/00; G01P 3/36

(52) U.S. Cl. CPC G01N 21/84; G01P 15/00; G01P 3/36

(57) ABSTRACT

A method, comprising: measuring a rotational speed of a wheel of a vehicle, determining a longitudinal acceleration of the vehicle relative to a plurality of ambient terrestrial objects using a measurement system onboard the vehicle, determining a longitudinal speed of the vehicle relative to the plurality of ambient terrestrial objects using the measurement system, judging a slippage state of the vehicle using the longitudinal acceleration, and if a result of the judging indicates the vehicle is in a low-slippage state, estimating a coefficient of traction using the rotational speed and the longitudinal speed, wherein the measurement system is structured to radiate electromagnetic energy and to receive reflections of the electromagnetic energy reflected from the plurality of ambient terrestrial objects.

### BACKGROUND OF THE DISCLOSURE

### Field of the Disclosure

The present disclosure relates to a method for estimating a coefficient of traction. The present disclosure relates to a system for estimating a coefficient of traction.

### Description of the Related Art

To increase the safety of a motor vehicle, an accurate knowledge of the road condition and of the coefficient of friction potential resulting therefrom, i.e. the maximum coefficient of friction between tires and road, is essential.

Various techniques are known for estimating a coefficient of friction between the tires of a vehicle and a road surface. The coefficient of friction potential depends on a plurality of coefficient of friction parameters. In particular the roadway condition, i.e. whether the surface of the roadway is dry, wet, snowy, or icy, is an important influencing factor.

The present disclosure expounds upon this background.

### SUMMARY OF THE PRESENT DISCLOSURE

The aim of the present summary is to facilitate understanding of the present disclosure. The summary thus presents concepts and features of the present disclosure in a more simplified form and in looser terms than the detailed description below and should not be taken as limiting other portions of the present disclosure.

Loosely speaking, the present disclosure teaches use of an onboard measurement system that radiates electromagnetic energy and receives reflections of the electromagnetic energy reflected from ambient terrestrial objects to measure a longitudinal acceleration and a longitudinal speed of a vehicle. Such a measurement system may be used to obtain a realistic assessment of the longitudinal acceleration of the vehicle relative to the road surface in a complex ambient road topology, for example on a steeply sloped road. Further, such a measurement system may be used to obtain a high accuracy measurement of the longitudinal speed of a vehicle with low latency, e.g. an accuracy of ±0.05% and a latency of less than 200 ms. The accuracy provided by such a measurement system may be exploited to distinguish between various road surfaces and/or between various road surface conditions, e.g. as a basis for estimating a coefficient of friction between the tires of a vehicle and a road surface.

Still loosely speaking, the present disclosure teaches performing a plurality of data acquisitions while a vehicle is judged to be in a low-slippage state, each individual data acquisition comprising estimating a virtual wheel radius and adding the virtual wheel radius to a data pool as virtual wheel radius data. The virtual wheel radius data of the data pool may be used to estimate a coefficient of friction between the tires of the vehicle and a road surface. The accuracy provided by such a pool of data may be exploited to distinguish between various road surfaces and/or between various road surface conditions, e.g. as a basis for estimating a coefficient of friction between the tires of a vehicle and a road surface.

Other objects, advantages and embodiments of the present disclosure will become apparent from the detailed description below, especially when considered in conjunction with the accompanying drawings.

### BRIEF DESCRIPTION OF THE DRAWINGS

The Figures show:

FIG. 1: shows a method in accordance with the present disclosure,

FIG. 2: shows a diagram with different wheel radii on different road surfaces and the different coefficient of friction potentials,

FIG. 3: shows a motor vehicle in accordance with the present disclosure, and

FIG. 4: schematically shows a system in accordance with the present disclosure.

### DETAILED DESCRIPTION

The various embodiments of the present disclosure and of the claimed invention, in terms of both structure and operation, will be best understood from the following detailed description, especially when considered in conjunction with the accompanying drawings.

Before elucidating the embodiments shown in the Figures, the various embodiments of the present disclosure will first be described in general terms.

The present disclosure teaches a method, e.g. a method for estimating a coefficient of traction. In the present disclosure, the expression “coefficient of traction” may be understood in its ordinary meaning, e.g. in accordance with the dictionary definitions of its constituent words. Similarly, the expression “coefficient of traction” may be understood in the present disclosure as a coefficient of friction between the tires of a vehicle and a road surface, e.g. that enables a driving/braking force parallel to a longitudinal axis of the vehicle. In the present disclosure, the expression “longitudinal axis of the vehicle” may be understood as an axis that represents a “straight” driving direction of the vehicle.

The method may comprise measuring a rotational speed of a wheel of a vehicle. More generally, the method may comprise measuring, for at least one wheel of the vehicle, a rotational speed of the respective wheel. The rotational speed may be measured in radians per second (i.e. rad/s), revolutions per minute, degrees per second, or other suitable units. The wheel may be a driven wheel or an undriven wheel. The wheel may be a driven wheel that transmits a driving force from an engine and/or motor to a tire of the wheel, which tire frictionally engages a road surface to propel the vehicle. The wheel may be an undriven wheel that is not connected to or is disconnected from an engine and/or motor, e.g. a wheel that rotates solely/primarily on account of frictional engagement with a road surface. The measurement may be effected using a sensor, e.g. a wheel speed sensor or rotational speed sensor. The sensor may be a contactless sensor. The sensor may be a magnetic and/or optical sensor.

The method may comprise determining a longitudinal acceleration of the vehicle and/or a longitudinal speed of the vehicle, e.g. relative to a plurality of ambient terrestrial objects. Similarly, the method may comprise determining a transverse acceleration of the vehicle, e.g. relative to a plurality of ambient terrestrial objects. More generally, the method may comprise measuring an acceleration and/or a velocity of the vehicle, e.g. relative to a plurality of ambient terrestrial objects. The method may comprise determining a longitudinal acceleration and/or a transverse acceleration from the measured acceleration. Similarly, the method may comprise determining a longitudinal speed and/or a transverse speed from the measured velocity. The measurement may be performed by a measurement system, e.g. a measurement system onboard the vehicle. Similarly, the method may comprise measuring a respective distance between the vehicle and the plurality of ambient terrestrial objects (individually) at at least two points in time and determining the transverse/longitudinal acceleration and/or the transverse/longitudinal of the vehicle from the measured distances. Again, the measurements may be performed by a measurement system onboard the vehicle,

As detailed later in the present disclosure, measurement of an acceleration and/or velocity of the vehicle and/or measurement of a distance between the vehicle and individual ambient terrestrial objects may be based on reflections of electromagnetic energy radiated from the measurement system, As such, the determining of the transverse/longitudinal acceleration and/or the transverse/longitudinal of the vehicle may use reflections of electromagnetic energy, e.g. reflections of electromagnetic energy radiated from the measurement system.

The method may comprise a plurality of measurement cycles, e.g. a plurality of consecutive measurement cycles. The individual measurement cycles may be of equal duration, e.g. of a duration of at least 20 ms, at least 50 ms, or at least 100 ms and/or a duration of less than one second, less than 500 ms, less than 200 ms, or less than 100 ms. The individual measurement cycles may be of a duration that corresponds to a cycle time of the measurement system, e.g. to a cycle time of a radar sub-system of the measurement system. The method may comprise performing certain measurements at regular intervals, e.g. once per measurement cycle. For example, the method may comprise measuring the longitudinal speed of the vehicle once per measurement cycle. As such, each individual measurement of the longitudinal speed of the vehicle may be associated with an individual measurement cycle. The method may comprise performing, per measurement cycle, one measurement representative of an acceleration of the vehicle and a set of measurements representative, for each of at least one wheel, of a rotational speed of the respective wheel. As such, each such one measurement/set of measurements may be associated with an individual measurement cycle. The set of measurements may comprise at least 20, at least 50, at least 100, or at least 200 measurements representative, for each of at least one wheel, of a rotational speed of the respective wheel.

The plurality of ambient terrestrial objects may comprise at least 20, at least 50, at least 100, or at least 200 objects. The plurality of ambient terrestrial objects may consist of less than 50, less than 100, or less than 200 objects. The plurality of ambient terrestrial objects may comprise animate and/or inanimate objects. The plurality of ambient terrestrial objects may comprise/consist of stationary and/or quasi-stationary objects. The plurality of ambient terrestrial objects may comprise/consist of objects that are affixed to and/or touch the ground. For example, the plurality of ambient terrestrial objects may comprise trees, buildings, people, fences, parked vehicles, and/or signs. The plurality of ambient terrestrial objects may be located within a radius of 400 m, 200 m, or 100 m from the vehicle. For each of the plurality of ambient terrestrial objects, the minimum distance from the vehicle to the respective individual object may be less than 400 m, less than 200 m, or less than 100 m.

In the present disclosure, the expression “longitudinal acceleration”/“longitudinal speed” may be understood in its ordinary meaning, e.g. in accordance with dictionary definitions of its constituent words. Similarly, the expression “longitudinal acceleration”/“longitudinal speed” may be understood in the present disclosure as an acceleration/speed of the vehicle in a direction parallel to a longitudinal axis of the vehicle. In the present disclosure, the expression “transverse acceleration”/“transverse speed” may be understood in its ordinary meaning, e.g. in accordance with dictionary definitions of its constituent words. Similarly, the expression “transverse acceleration”/“transverse speed” may be understood in the present disclosure as an acceleration/speed of the vehicle in a direction perpendicular to a longitudinal axis of the vehicle. The expression “transverse acceleration” may be understood as “lateral acceleration”. Similarly, the expression “transverse speed” may be understood as “lateral speed”.

The method may comprise estimating a coefficient of traction. Estimation of the coefficient of traction may comprise estimating a virtual wheel radius for a respective wheel of the vehicle. The virtual wheel radius may be estimated using a measured rotational speed of the respective wheel and an estimated longitudinal speed of the vehicle, e.g. by dividing the estimated longitudinal speed by the measured rotational speed. The estimated longitudinal speed may be a longitudinal speed estimated using measurements carried out during the same measurement cycle as measurement of the measured rotational speed. A measurement cycle associated with an estimated longitudinal speed used to estimate a respective virtual wheel radius may be designated as a measurement cycle associated with the respective virtual wheel radius.

Estimation of the coefficient of traction may comprise estimating a plurality of virtual wheel radii, e.g. at least 40, at least 80, at least 120, or at least 200 virtual wheel radii. Each virtual wheel radius of the plurality of virtual wheel radii may be individually estimated as described above, e.g. using a respective longitudinal speed and a respective rotational speed, where the respective longitudinal speed is estimated using measurements carried out during the same measurement cycle as measurement of the respective rotational speed. The total set of estimated longitudinal speeds used to estimate the plurality of virtual wheel radii may consist of five estimated longitudinal speeds (obtained, one per measurement cycle, from five contiguous measurement cycles), four estimated longitudinal speeds (obtained, one per measurement cycle, from four contiguous measurement cycles), three estimated longitudinal speeds (obtained, one per measurement cycle, from three contiguous measurement cycles), two estimated longitudinal speeds (obtained, one per measurement cycle, from two contiguous measurement cycles), or one estimated longitudinal speed.

Estimation of the coefficient of traction may comprise estimating, for at least one wheel of the vehicle, a respective virtual wheel radius for at least one measurement of the rotational speed of the respective wheel. For example, estimation of the coefficient of traction may comprise estimating, for each of four wheels of the vehicle, a respective virtual wheel radius for thirty measurements of the rotational speed of the respective wheel. In such a case, estimation of the coefficient of traction may comprise estimating 120 virtual wheel radii. Similarly, estimation of the coefficient of traction may comprise estimating, for each of two wheels of the vehicle, a respective virtual wheel radius for each of 80 measurements of the rotational speed of the respective wheel. In such a case, estimation of the coefficient of traction may comprise estimating 160 virtual wheel radii.

The method may comprise calculating a general estimation of the virtual wheel radius, e.g. using more than one estimated virtual wheel radius. For example, the method may comprise calculating a general estimation of the virtual wheel radius using the aforementioned plurality of at least 40, at least 80, at least 120, or at least 200 estimated virtual wheel radii. The calculating of a general estimation of the virtual wheel radius may comprise mathematically combining an estimated virtual wheel radius and at least one other estimated virtual wheel radius. For example, (a set of values consisting of) more than one estimated virtual wheel radius may be mathematically combined by averaging (the values in the set), by selecting a median value (from the values in the set), or by calculating a truncated mean (using selected values of the set, a truncated mean being an average discarding several highest/lowest values).

The method may comprise estimating a coefficient of traction by comparing an estimated virtual wheel radius with data that map virtual wheel radius values to coefficients of traction. Similarly, the method may comprise estimating a coefficient of traction by comparing a general estimation of the virtual wheel radius with data that map virtual wheel radius values to coefficients of traction. The data may map virtual wheel radius values to a set of less than twenty or less than ten coefficients of traction.

The method may comprise adding any estimated virtual wheel radius to a data pool, e.g. as virtual wheel radius data. (An elucidation of the term “any” is given in the closing paragraphs of this specification.) The method may comprise retrieving more than one estimated virtual wheel radius from the data pool, e.g. for use in calculating a general estimation of the virtual wheel radius. The method may comprise estimating a coefficient of traction using the virtual wheel radius data of the data pool, e.g. by mathematically combining the virtual wheel radius data. The method may comprise limiting the data pool such that a total set of estimated longitudinal speeds used to estimate the virtual wheel radius data in the data pool does not exceed five/four/three/two estimated longitudinal speed(s) obtained, one per measurement cycle, from five/four/three/two contiguous measurement cycles. The method may comprise limiting the data pool such that a total set of estimated longitudinal speeds used to estimate the virtual wheel radius data in the data pool does not exceed one estimated longitudinal speed.

The method may comprise judging a slippage state of the vehicle, e.g. once per measurement cycle. Estimation of a coefficient of traction may be conditioned on whether the judging for a current measurement cycle indicates the vehicle is in a low-slippage state. Estimation of a coefficient of traction may be effected exclusively on the condition that a result of the judging for a current measurement cycle indicates the vehicle is in a low-slippage state. Estimation of a coefficient of traction may be conditioned on whether the judging for the one/two most recent measurement cycle(s) indicates the vehicle has been in a low-slippage state. Estimation of a coefficient of traction may be effected exclusively on the condition that a result of the judging for the one/two most recent measurement cycle(s) indicates the vehicle has been in a low-slippage state.

In the present disclosure, slip may be understood to be the deviation of the wheel revolutions relative to the total distance, which has to be covered; i.e. generally the deviation of the speeds of mechanical elements, which are in frictional contact with one another, under tangential load. During braking, the slip is the ratio of the speed of the rubber relative to the roadway to the speed of the motor vehicle; wherein the tire adheres in the case of a slip of close to 0 and the tire blocks in the case of a slip of 100%. A state in which at least one wheel of the vehicle exhibits slippage of less than 0.02 may be deemed a low-slippage state. Similarly, a state in which at least two wheels or every wheel of the vehicle exhibits slippage of less than 0.02 may be deemed a low-slippage state.

The method may use an estimated longitudinal acceleration to judge the slippage state of the vehicle. A longitudinal acceleration greater than 0.5 m/s² may be considered to indicate that the vehicle is not in a low-slippage state. The method may use an estimated transverse acceleration to judge the slippage state of the vehicle. A transverse acceleration greater than 0.5 m/s² may be considered to indicate that the vehicle is not in a low-slippage state. The method may use an estimated longitudinal speed and an estimated transverse speed to judge the slippage state of the vehicle. A transverse speed greater than 1% of the longitudinal speed may be considered to indicate that the vehicle is not in a low-slippage state.

The method may comprise performing a plurality of data acquisitions, e.g. at least 50, at least 100, or at least 200 data acquisitions. The plurality of data acquisitions may be performed in a contiguous time period of less than one second, less than 500 ms, less than 200 ms, or less than 100 ms in duration. The plurality of data acquisitions may be performed within a respective measurement cycle. Each individual data acquisition may comprise performing a measurement, e.g. as described above, representative of a rotational speed of a wheel of the vehicle. Each individual data acquisition may comprise estimating a virtual wheel radius, e.g. as described above. Each individual data acquisition may comprise adding the virtual wheel radius to a data pool, e.g. as described above. Performance of the data acquisition may be conditioned on a result of the judging (e.g. based on a most recently estimated longitudinal acceleration). For example, the data acquisition may be performed while a result of the judging (e.g. based on a most recently estimated longitudinal acceleration) indicates the vehicle is in a low-slippage state. The data acquisition may be ceased while a result of the judging (e.g. based on a most recently estimated longitudinal acceleration) indicates the vehicle is not in a low-slippage state.

Use of an estimated virtual wheel radius in estimating a coefficient of traction may be conditioned on a judging result (as detailed below), the estimated virtual wheel radius being used in estimating the coefficient of traction if the judging result is affirmative and the estimated virtual wheel radius being withheld from being used in estimation of the coefficient of traction otherwise.

As already stated above, the method may comprise adding any estimated virtual wheel radius to the data pool. The respective estimated virtual wheel radius may be added to the data pool in association with a respective judging result (as detailed below) that is likewise added to the data pool. Similarly, the adding of an estimated virtual wheel radius to the data pool may be conditioned on a respective judging result (as detailed below), the estimated virtual wheel radius being added to the data pool if the judging result is affirmative and the estimated virtual wheel radius being withheld from the data pool otherwise.

The method may comprise assessing a judging result for an estimated virtual wheel radius. The judging result for an estimated virtual wheel radius is affirmative if the result(s) of the judging for the measurement cycle associated with the respective virtual wheel radius (as well as for the one/two measurement cycle(s) most closely preceding the measurement cycle associated with the respective virtual wheel radius) indicate that the vehicle was in a low-slippage state during that/those measurement cycle(s).

Use of an estimated virtual wheel radius retrieved from the data pool in estimating a coefficient of traction may be conditioned on the judging result (also retrieved from the data pool) associated with the respective estimated virtual wheel radius, the estimated virtual wheel radius being used in estimating the coefficient of traction if the judging result is affirmative and the estimated virtual wheel radius being withheld from being used in estimation of the coefficient of traction otherwise.

The method, e.g. the determining of a longitudinal acceleration of the vehicle and/or a longitudinal speed of the vehicle and/or a transverse acceleration of the vehicle, may comprise emitting/radiating electromagnetic energy, e.g. within a frequency band of 10 to 100 GHz and/or within a wavelength range of 600 to 1000 nm. The method may comprise radiating the electromagnetic energy in a plurality of directions, e.g. over an azimuthal range of at least ±15°, at least ±20°, at least ±25°, or at least ±30° (from a central plane oriented parallel, within ±2° of parallel, or within ±4° of parallel to a longitudinal axis of the vehicle and vertical, within ±2° of vertical, or within ±4° of vertical when the vehicle is on a horizontal surface). The electromagnetic energy may be radiated from a front of the vehicle.

The method, e.g. the determining of a longitudinal acceleration of the vehicle and/or a longitudinal speed of the vehicle and/or a transverse acceleration of the vehicle, may comprise receiving reflections of the radiated electromagnetic energy, e.g. reflections reflected from the plurality of ambient terrestrial objects. More generally, the method may comprise receiving reflections of the radiated electromagnetic energy reflected from a plurality of ambient targets, inter alia from the aforementioned plurality of ambient terrestrial objects. The method may comprise distinguishing reflections received from one of the plurality of ambient targets from reflections received from at least 20, at least 50, at least 100, or any other of the plurality of ambient targets. As such, the method may comprise distinguishing reflections received from one of the plurality of ambient terrestrial objects from reflections received from at least 20, at least 50, at least 100, or any other of the plurality of ambient terrestrial objects.

The method, e.g. the determining of a longitudinal acceleration of the vehicle and/or a longitudinal speed of the vehicle and/or a transverse acceleration of the vehicle, may comprise estimating a velocity of the vehicle (relative to a respective ambient target) based on a change in distance to the ambient target over time. The method may comprise measuring a first distance to the ambient target based on a first time between a first emission of electromagnetic energy and a reception of a reflection of the first emission of electromagnetic energy. Similarly, the method may comprise measuring a second distance to the ambient target based on a second time between a second emission of electromagnetic energy and a reception of a reflection of the second emission of electromagnetic energy. The method may comprise estimating the velocity of the vehicle based on a difference between the first and second distance relative to a difference between the first and second time. The method may comprise using an angle between a central plane of the measurement system and the ambient target to resolve the estimated velocity into a longitudinal speed and/or a transverse speed.

The method may comprise estimating a velocity of the vehicle (relative to a respective ambient target) based on the Doppler effect, i.e. based on a frequency shift between emitted electromagnetic energy and a reflection of that emitted electromagnetic energy reflected from the ambient target. The method may comprise using an angle between a central plane of the measurement system and the ambient target to resolve the estimated velocity into a longitudinal speed and/or a transverse speed.

For at least one of the plurality of ambient targets individually, e.g. for each of the plurality of ambient targets individually, the method may comprise estimating the velocity of the vehicle (relative to the respective individual target) multiple times within a certain time period. For example, the method may comprise estimating the velocity of the vehicle (relative to a respective ambient target) at least 5 times, at least 10 times, or at least 20 times within a time period spanning less than 1 second, less than 500 ms, or less than 200 ms. Any such estimation of the velocity of the vehicle may comprise resolving the estimated velocity into a longitudinal speed and/or a transverse speed, e.g. as described above. The method may comprise using the multiple estimates of the velocity (relative to any individual target) to calculate yet another (refined) estimate of the velocity of the vehicle (relative to the respective individual target), e.g. by averaging, by selecting a median value, or by calculating a truncated mean (i.e. an average discarding several highest/lowest values). Similarly, the method may comprise using the multiple estimates of the longitudinal/transverse speed of the vehicle (relative to any individual target) to calculate a (refined) estimate of the longitudinal/transverse speed of the vehicle (relative to the respective individual target), e.g. by averaging, by selecting a median value, or by calculating a truncated mean (i.e. an average discarding several highest/lowest values). Alternatively, the method may comprise using an angle between a central plane of the measurement system and the ambient target to resolve the (refined) estimate of the velocity (relative to the respective individual target) into a longitudinal speed and/or a transverse speed.

The method, e.g. the determining of a longitudinal acceleration of the vehicle and/or a longitudinal speed of the vehicle and/or a transverse acceleration of the vehicle, may comprise estimating an acceleration of the vehicle (relative to a respective ambient target) based on a change in velocity/speed relative to the ambient target over time. The method may comprise estimating a first longitudinal/transverse speed of the vehicle (relative to the ambient target) at a first time and may estimate a second longitudinal/transverse speed of the vehicle (relative to the ambient target) at a second time, e.g. as described above. The method may comprise estimating the acceleration of the vehicle based on a difference between the first and second longitudinal/transverse speed relative to a difference between the first and second time. Similarly, the method may comprise estimating a first velocity of the vehicle (relative to the ambient target) at a first time and may estimate a second velocity of the vehicle (relative to the ambient target) at a second time, e.g. as described above. The method may comprise estimating the acceleration of the vehicle based on a difference between the first and second velocity relative to a difference between the first and second time. The method may comprise using an angle between a central plane of the measurement system and the ambient target to resolve an acceleration estimated from two velocities into a longitudinal acceleration and/or a transverse acceleration.

The method, e.g. the determining of a longitudinal acceleration of the vehicle and/or a longitudinal speed of the vehicle and/or a transverse acceleration of the vehicle, may comprise distinguishing (quasi-)stationary targets from moving targets, e.g. using statistical analysis of a sample set consisting of the respective longitudinal speed of the vehicle as estimated, for each of the plurality of ambient targets, relative to the respective individual target. Due to the fact that the longitudinal speed of the vehicle as estimated relative to a stationary target (which many ambient targets in a non-barren environment inevitably are) will fall within a narrow range of the actual longitudinal speed of the vehicle, whereas the longitudinal speed of the vehicle as estimated relative to a moving target usually depends on the more or less random velocity of the respective moving target, the sample set will contain a recognizable percentage (typically greater than 20%) of longitudinal speed estimates clustered around a certain value, while the remaining longitudinal speed estimates of the sample set will extremely rarely exhibit such a large percentage of clustered values. The method may comprise deeming a target associated with a longitudinal speed estimate that is clustered with a significant percentage (e.g. greater than 20%) of other longitudinal speed estimates in the sample set to be a (quasi-)stationary target. In the present context, a subset of longitudinal speed estimates may be considered “clustered” if no two longitudinal speed estimates of the subset differ more than the nominal accuracy, 1.5 times the nominal accuracy, or twice the nominal accuracy of the measurement system as regards measurement of the longitudinal speed of the vehicle relative to an ambient target. The method may comprise measuring the longitudinal speed of the vehicle relative to an ambient target with a nominal accuracy better than 0.4 km per hour or better than 0.2 km per hour.

The method may comprise distinguishing (quasi-)stationary targets from moving targets by comparing the longitudinal speed of the vehicle as estimated relative to the target in question to the longitudinal speed of the vehicle as estimated relative to at least one target previously deemed to be (quasi-)stationary. The target in question may deemed to be (quasi-)stationary if a difference between the longitudinal speed of the vehicle as estimated relative to the target in question to the longitudinal speed of the vehicle as estimated relative to at least one target previously deemed to be (quasi-)stationary is less than a threshold value (stored in a memory of the measurement system), e.g. less than 0.4 km per hour or less than 0.2 km per hour.

The method may comprise selecting a subset of the plurality of ambient targets as good targets. The method may comprise selecting targets deemed to be (quasi-)stationary as good targets. The set of good targets may consist exclusively of targets deemed to be (quasi-) stationary. The plurality of ambient terrestrial objects may comprise/consist of the set of good targets.

The measurement system may comprise a camera, The method may comprise using the camera to individually identify ambient targets, e.g. using image recognition. The method may comprise correlating individual ambient targets identified using the camera with individual ambient targets distinguished using reflections of the radiated electromagnetic energy. The method may comprise selecting targets identified as immobile—i.e. stationary—objects (fences, trees, buildings, benches, and signs, for example) as good targets. As such, the method may comprise using the camera to identify at least one individual object belonging to the plurality of ambient terrestrial objects.

The method, e.g. the determining of a longitudinal speed of the vehicle, may comprise calculating a general estimation of the longitudinal speed of the vehicle (relative to the plurality of ambient terrestrial objects). The calculating of a general estimation of the longitudinal speed of the vehicle may comprise mathematically combining, for at least two targets belonging to the set of good targets, the respective longitudinal speed estimated relative to the respective target. For example, the at least two longitudinal speeds (associated with good targets) may be mathematically combined by averaging, by selecting a median value, or by calculating a truncated mean (i.e. an average discarding several highest/lowest values). The disclosed method of determining a longitudinal speed of the vehicle may yield a result accurate to within ±0.05%. For example, the general estimation of the longitudinal speed of the vehicle may represent the actual longitudinal speed of the vehicle (relative to an ambient road surface) with an accuracy of ±0.05%.

The method, e.g. the determining of a longitudinal acceleration of the vehicle, may comprise calculating a general estimation of the longitudinal acceleration of the vehicle (relative to the plurality of ambient terrestrial objects). The calculating of a general estimation of the longitudinal acceleration of the vehicle may comprise mathematically combining, for at least two targets belonging to the set of good targets, the respective longitudinal acceleration estimated relative to the respective target. For example, the at least two longitudinal accelerations (associated with good targets) may be mathematically combined by averaging, by selecting a median value, or by calculating a truncated mean (i.e. an average discarding several highest/lowest values).

The method, e.g. the determining of a transverse acceleration of the vehicle, may comprise calculating a general estimation of the transverse acceleration of the vehicle (relative to the plurality of ambient terrestrial objects). The calculating of a general estimation of the transverse acceleration of the vehicle may comprise mathematically combining, for at least two targets belonging to the set of good targets, the respective transverse acceleration estimated relative to the respective target. For example, the at least two transverse accelerations (associated with good targets) may be mathematically combined by averaging, by selecting a median value, or by calculating a truncated mean (i.e. an average discarding several highest/lowest values).

The present disclosure teaches a system. The system may (be structured to) effect (any part of) the method disclosed in the present disclosure.

The system may comprise a rotational speed sensor may (be structured to) measure a rotational speed of a wheel of a vehicle, e.g. as described above.

The system may comprise a measurement system. The measurement system may (be structured to) determine a longitudinal acceleration of the vehicle and/or a longitudinal speed of the vehicle, e.g. as described above.

The measurement system may (be structured to) emit/radiate electromagnetic energy, e.g. as described above. For example, the measurement system may comprise a radar and/or a Doppler radar. The measurement system may emit/radiate electromagnetic energy within a frequency band of 10 to 100 GHz. Similarly, the measurement system may comprise a laser, e.g. as a component of a laser scanning/lidar sub-system of the measurement system. The measurement system may emit/radiate electromagnetic energy within a wavelength range of 600 to 1000 nm. As such, the measurement system may comprise a radio transmitter that transmits radio energy at at least one frequency greater than 10 GHZ and less than 100 GHz. Similarly, the measurement system may comprise a laser that emits light at at least one wavelength greater than 600 nm and less than 1000 nm.

The measurement system may radiate the electromagnetic energy in a plurality of directions, e.g. over an azimuthal range of at least ±15°, at least ±20°, at least ±25°, or at least ±30° (from a central plane of the measurement system). The measurement system may be mounted to the vehicle, e.g. to a front of the vehicle, such that the central plane of the measurement system is parallel, within ±2° of parallel, or within ±4° of parallel to a longitudinal axis of the vehicle and vertical, within ±2° of vertical, or within ±4° of vertical when the vehicle is on a horizontal surface. To effect radiation of the electromagnetic energy in a plurality of directions, the measurement system may comprise a scanning mechanism and/or a phased array. The scanning mechanism/phased array may alter a radiation direction of the electromagnetic energy over time.

The measurement system may (be structured to) receiving reflections of the radiated electromagnetic energy, e.g. as described above.

The measurement system may (be structured to) estimate a velocity of the vehicle, e.g. as described above. Similarly, the measurement system may (be structured to) estimate an acceleration of the vehicle, e.g. as described above.

The measurement system may (be structured to) distinguish (quasi-)stationary targets from moving targets, e.g. as described above.

As already stated above, the measurement system may comprise a camera. The measurement system may (be structured to) use the camera to identify at least one individual object belonging to the plurality of ambient terrestrial objects.

The following section may be considered distinct from the preceding disclosure. The following section may be likewise be read as complementing the preceding disclosure.

The term (motor) vehicle may be understood as two-wheel, four-wheel, or multi-wheel or single- or multi-axle (motor) vehicles, respectively, as well as two-wheelers, passenger cars, heavy goods vehicles, etc., in the case of which individual or several wheels or axles, respectively, are driven.

An essentially unaccelerated drive is a drive during which braking or accelerating takes place negligibly, i.e. unconsciously. However, smaller accelerations/braking in the virtually imperceptible range can occur.

In accordance with the present disclosure, the vehicle longitudinal speed may be detected independently of the wheel speed because this type of detection would lead to a vehicle longitudinal speed, which is not highly precise.

This means that during an unaccelerated drive, this ratio, here referred to as current virtual wheel radius, correlates with the coefficient of friction potential between tire and road, wherein the coefficient of friction potential can be estimated.

With the method in accordance with the present disclosure it is now possible to determine the coefficient of friction potential in the case of a freely rolling, unaccelerated motor vehicle.

In further formation, several virtual wheel radii can be determined within a predefined time. For example, several hundred values can thereby be recorded within one second.

The average value or median can subsequently be determined from these recorded values as current virtual wheel radius. Outliers can thus be eliminated, for example.

The most frequently occurring wheel radii can further also be used as current virtual wheel radius. The lowest value can also be used as current virtual wheel radius. If the lowest value is assumed as current virtual wheel radius and a corresponding low corresponding coefficient of friction potential, and if, for example, a corresponding setting of the driving speed takes place subsequently by means of the coefficient of friction potential, a quick full braking can be performed, for example, at any time with a small braking distance, from which a high driving safety with autonomous mode of operation can be ensured. Alternatively, a combination thereof can also be used.

In a further formation, the vehicle longitudinal speed can further be determined by means of a measured frequency change between a reflected signal, which is sent by the motor vehicle and received by the motor vehicle. A highly precise determination of the vehicle longitudinal speed is thus possible.

The signal is preferably generated by means of a radar (radar sensor) arranged on the motor vehicle and/or by means of an arranged Doppler radar (radar sensor). The radar sensor can thereby likewise measure the vehicle longitudinal speed by means of a Doppler effect. Doppler radar is identified as a radar, which has the technical conditions for utilizing the Doppler effect, the Doppler radar can in particular be an impulse Doppler radar.

The use of such a radar/Doppler radar is in particular advantageous because most motor vehicles have already integrated it or have it, respectively, so that no retrofitting of hardware is necessary.

Alternatively or optionally additionally, the vehicle longitudinal speed can be determined by means of a DGPS signal (Differential Global Positioning System), which is received by the motor vehicle. Alternatively or optionally additionally, the vehicle longitudinal speed can be determined by means of a highly precise optical laser arranged on the motor vehicle.

For example, a combination of these options can furthermore contribute to the clarification.

The detected current virtual wheel radius is preferably compared with at least one individual wheel radius or a range of individual wheel radii, wherein the individual wheel radius or the range of the individual wheel radii is coupled at least to the coefficient of friction potential for the current tires on an asphalted, preferably dry road.

The coefficient of friction potential (maximum coefficient of friction) on an asphalted dry road is known from the literature or from the manufacturer of the motor vehicle/tire. For example in the case of new tires, such as changing from winter to summer tires, the driver can thus be prompted to detect several current virtual wheel radii in the case of a suitable asphalted dry road. These virtual wheel radii are then evaluated and at least one individual reference value is determined based thereon, which reference value assigns the known coefficient of friction potential to the recorded current virtual wheel radius or to the range of individual wheel radii.

The individual wheel radius or the range of individual wheel radii can thereby be recorded manually by the driver in the case of an asphalted in particular dry road. For this purpose, the driver can be prompted via a display unit, for example, to set or to confirm the road surface, in particular dry asphalt, and to record such an individual wheel radius or such individual wheel radii, respectively, as reference values. The coefficient of friction potential for dry asphalt is then assigned to this reference value or these reference values, respectively.

Alternatively, several such measurements can be recorded, for example, in the case different weather, and several individual wheel radii can thus be generated, to which a coefficient of friction potential, which is known from the literature, is assigned. The coefficient of friction potential, which is to be estimated later, can thus be estimated more accurately.

In a further formation, the detected virtual wheel radius is compared with at least one stored wheel radius or a range of stored wheel radii, wherein the stored wheel radius or the range of stored wheel radii is coupled at least to the coefficient of friction potential for standard tires and/or the tire type for the vehicle type on an asphalted, in particular dry road.

Standard values, which are already included by the manufacturer of the tires/of the motor vehicle, can thereby be stored in a storage unit of the motor vehicle. They can have been generated individually for the vehicle type and the conventionally used tires. The detected current virtual wheel radius is compared with the stored wheel radius, and the coefficient of friction potential is estimated on the basis thereof.

The manufacturer can further also save several stored wheel radii for different surfaces in a database in the motor vehicle. This increases the estimation accuracy of the coefficient of friction potential.

Such a stored wheel radius can also always be used when no individual wheel radius was detected.

In a further formation, the estimated coefficient of friction potential is compared with a predefined threshold value, wherein a warning is output to the driver when the threshold value is not reached. In the case of a partially autonomous driving, the driver can thus, for example, take over the steering wheel himself.

The object is further solved by means of an estimation device for estimating a coefficient of friction potential between the wheels of a motor vehicle and a surface of a roadway during an essentially unaccelerated drive of the motor vehicle, the estimation device comprising at least one speed sensor for detecting a wheel speed of at least one wheel of the motor vehicle, wherein a sensor system for detecting a highly accurate vehicle longitudinal speed of the motor vehicle is provided as well as an evaluation unit for determining the ratio between the detected vehicle longitudinal speed and the wheel speed as current virtual wheel radius and for estimating the current coefficient of friction potential by means of the current virtual wheel radius.

The advantages of the method can thereby also be transferred to the estimation device.

The sensor system can further comprise at least one radar and/or Doppler radar, which is arranged on the motor vehicle, for measuring the vehicle longitudinal speed by means of a measured frequency change between a reflected signal sent by the radar and/or the Doppler radar and received by the motor vehicle.

The evaluation unit is furthermore preferably formed to compare the detected current virtual wheel radius with at least one individual wheel radius or a range of individual wheel radii, wherein the individual wheel radius or the range of individual wheel radii is coupled at least to the coefficient of friction potential for the current tires on an asphalted, in particular dry road. This individual wheel radius or the range of individual wheel radii, respectively, can be detected manually as reference value, for example when a driver prompts the motor vehicle.

In a further formation, a database can further be provided, comprising at least one stored wheel radius or a range of stored wheel radii, which is coupled at least to the coefficient of friction potential for standard tires and/or the tire type of a vehicle on an asphalted, in particular dry road, and by means of which the current coefficient of friction potential can be estimated by means of a comparison with the detected current virtual wheel radius.

A database can further also be provided, comprising at least several wheel radii, which are coupled to the coefficient of friction potential for standard tires and/or the tire type for the respective vehicle type on different road surfaces, and by means of which the current coefficient of friction potential can be estimated by means of a comparison with the detected current virtual wheel radius.

Such a database can be firmly preinstalled, for example by the vehicle manufacturer, depending on the vehicle type, in particular in the case of motor vehicles, which have a high autonomy stage. The database can further be present for winter tires and summer tires, so that the coefficient of friction potential can be estimated better. A cloud connection can also be provided, which routinely updates the database.

The object is further solved by means of a motor vehicle comprising an estimation device as described above and/or a method as described above.

The term motor vehicles is to thereby be understood as two-wheel, four-wheel, or multi-wheel or single- or multi-axle motor vehicles, respectively, as well as two-wheelers, passenger cars, heavy goods vehicles, busses, etc., in the case of which individual or several wheels or axles, respectively, are driven.

Tractors or tracked vehicles can also be comprised. The various embodiments of the present disclosure having been described above in general terms, the embodiments shown in the Figures will now be elucidated.

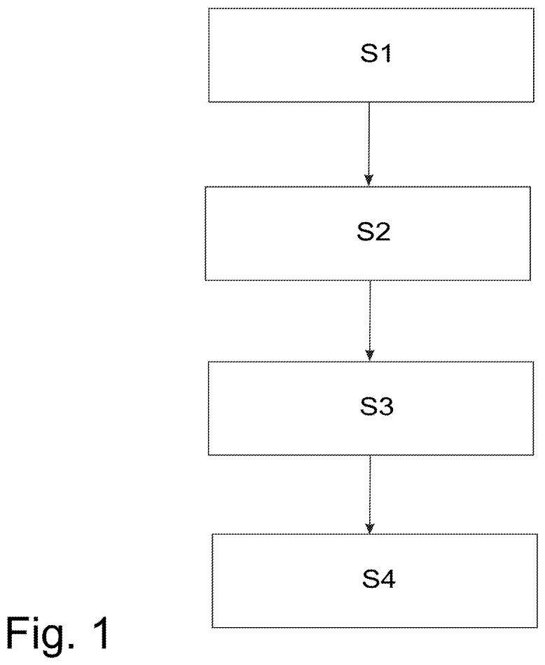

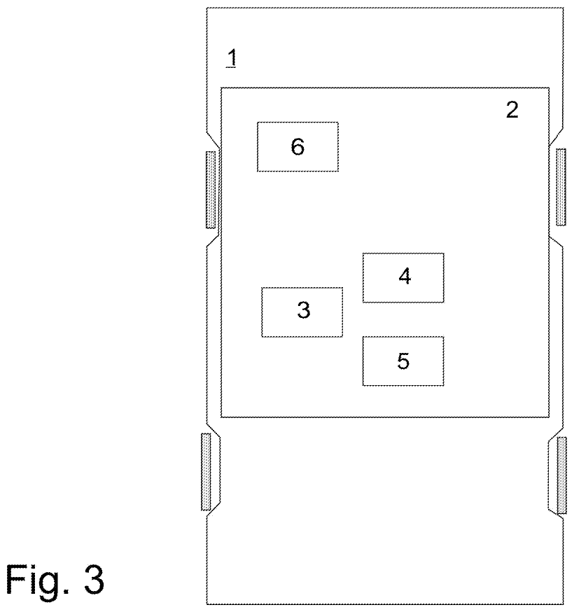

FIG. 1 shows a method for estimating a coefficient of friction potential between wheels of a motor vehicle 1 (FIG. 3) and a surface of a roadway by means of an estimation device 2 (FIG. 3) arranged in the motor vehicle 1 (FIG. 3).

The motor vehicle 1 (FIG. 3) thereby drives essentially so as to roll freely and unaccelerated, i.e. essentially in a slip-free manner.

In a step S1, the wheel speed is detected by means of a speed sensor 6 (FIG. 3) by one or several wheels of the motor vehicle 1 (FIG. 3). Such speed sensors 6 (FIG. 3) are already often an integral part in brake regulation systems and serve the purpose of determining the rotational speed of wheels, i.e. the wheel speed in a contact-free manner.

In a second step S2, the vehicle longitudinal speed of the motor vehicle 1 (FIG. 3) is detected highly precisely. The longitudinal speed is essentially the speed of the motor vehicle 1 (FIG. 3) in the longitudinal direction of the vehicle body.

To determine such a vehicle longitudinal speed highly precisely in the case of a freely rolling motor vehicle 1 (FIG. 3), a radar (sensor) or a Doppler radar (sensor) 3 (FIG. 3) is preferably used. This is already often an integral part, in particular in autonomously driving motor vehicles.

The vehicle longitudinal speed of the motor vehicle 1 (FIG. 3) can be detected highly accurately (Doppler effect) by means of the radar/Doppler radar 3 by means of a measured frequency change between a reflected signal sent by the radar and/or the Doppler radar 3 (FIG. 3) and received by the motor vehicle 1 (FIG. 3), namely independently of a speed sensor. The vehicle longitudinal speed of the motor vehicle 1 (FIG. 3) can be determined highly efficiently and highly accurately by means of the detection of the highly accurate vehicle longitudinal speed with the help of the radar/Doppler radar 3 (FIG. 3).

Alternatively or additionally, the vehicle longitudinal speed can be determined by means of a DGPS signal (Differential Global Positioning System) received by the motor vehicle 1 (FIG. 3). The vehicle longitudinal speed can likewise be determined precisely by means of such a signal.

The vehicle longitudinal speed can further be determined by means of a highly precise contact-free optical laser, which is arranged on the motor vehicle 1 (FIG. 3). For this purpose, an optical laser camera for detecting a textured surface, such as the road surface, can be mounted to the motor vehicle 1 (FIG. 3), which is based, for example, on triangulation as evaluation method. The measured values of such an optical laser can in particular be robust against pitching, rolling, and height changes of the motor vehicle 1 (FIG. 3).

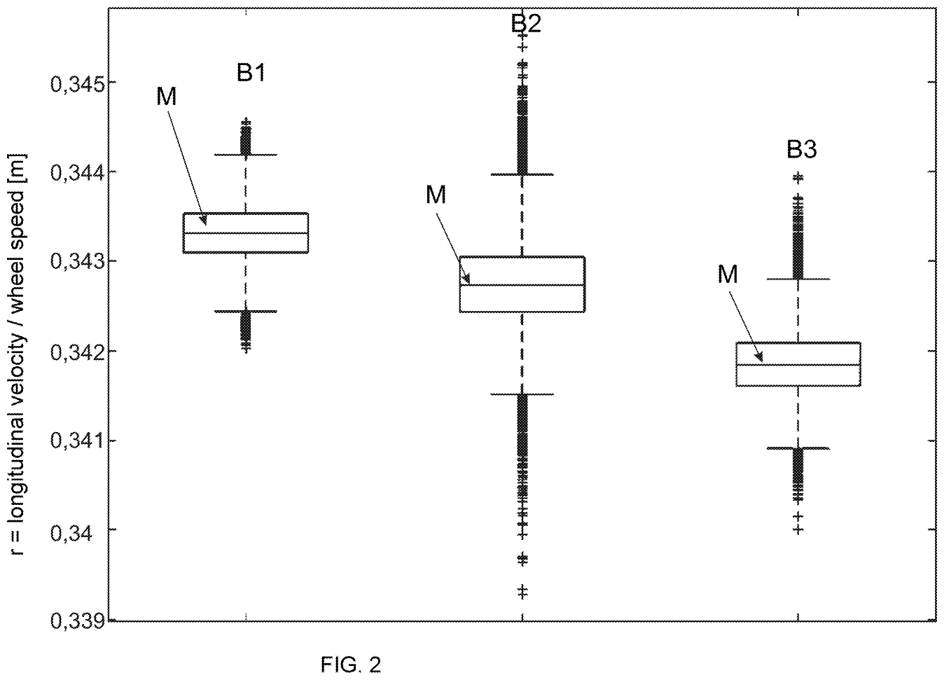

In a third step S3, the ratio, here the quotient between the detected vehicle longitudinal speed and the wheel speed, is subsequently determined as current virtual wheel radius r (FIG. 2).

Several such virtual wheel radii r are preferably determined within a specified time. For example, several such virtual wheel radii r (FIG. 2) can thus be measured within one second.

For example, the average value or median can subsequently be determined from these recorded wheel radii as current virtual wheel radius r (FIG. 2).

The average value or median can subsequently be determined from these recorded wheel radii as current virtual wheel radius r (FIG. 2). Outliers can thus be eliminated, for example. The most frequently occurring value can further also be used as current virtual wheel radius r (FIG. 2). The lowest value can also be used as current virtual wheel radius r (FIG. 2). If the lowest value is used as current virtual wheel radius r (FIG. 2), and a correspondingly low corresponding coefficient of friction potential μ is assumed, and if a corresponding setting of the driving speed takes place subsequently, for example, by means of the coefficient of friction potential μ, a quick full braking can be performed, for example, at any time with a small braking distance, from which a high driving safety with autonomous mode of operation can be ensured.

Alternatively, a combination thereof can also be used.

The current coefficient of friction potential μ can now be determined by means of the current virtual wheel radius r (FIG. 2).

For this purpose, the current virtual wheel radius r (FIG. 2) is compared with an individually generated and stored wheel radius r (FIG. 2), fourth step S4.

The individually generated and stored wheel radius r (FIG. 2) can be, for example, an individual wheel radius r (FIG. 2), which was recorded manually by a driver in the case of an asphalted dry road. For this purpose, the driver can be prompted, for example after a tire change or independently via a display unit, to set or to confirm the road surface, in particular dry asphalt, and to record the recorded wheel radius r (FIG. 2) as individual wheel radius r (FIG. 2) and thus as reference value. This individual wheel radius r (FIG. 2) is coupled to a coefficient of friction potential μ, which is known from the literature. The coefficient of friction potential μ thereby corresponds to the maximum coefficient of friction between tires and road.

Several such individual wheel radii r (FIG. 2) are preferably detected and, for example, an average value or median is formed as reference value and is stored in the motor vehicle 1 (FIG. 3).

Such an individual wheel radius r (FIG. 2) is thus then used on an asphalted, dry road with current tires as reference value, which is coupled to a coefficient of friction potential μ for an asphalted, dry road.

Alternatively, several such measurements can thus be recorded, for example in the case of different weather or different road surfaces, respectively, and several individual wheel radii can thus be generated, to which a known coefficient of friction potential μ is assigned from the literature or from the vehicle manufacturer directly. The coefficient of friction potential μ, which is to be estimated later, can thus be estimated more accurately.

A database 5 (FIG. 3) can further also be provided, in which at least one wheel radius r (FIG. 2) or a range of stored wheel radii r (FIG. 2) is stored as reference value, wherein the wheel radius r (FIG. 2) is coupled at least to the coefficient of friction potential μ for standard tires and/or the tire type of a respective vehicle type on an asphalted dry road. A database 5 (FIG. 3) can further also be provided, in which at least several wheel radii r are provided, which are coupled to the coefficient of friction potential μ for standard tires and/or the tire type of a respective vehicle type on different road surfaces, and by means of which the current coefficient of friction potential μ can be estimated by means of a comparison with the detected current virtual wheel radius r (FIG. 2).

Such a database 5 (FIG. 3) can be firmly preinstalled, for example by the vehicle manufacturer, depending on the vehicle type, in particular in the case of motor vehicles 1 (FIG. 3), which have a high autonomy stage. The database 5 (FIG. 3) can further be present for winter tires and summer tires, so that the coefficient of friction potential μ can be estimated better. A cloud connection can also be provided, which routinely updates the database 5 (FIG. 3).

The current coefficient of friction potential μ can be estimated by means of the comparison of the detected current virtual wheel radius r (FIG. 2) and the stored wheel radius r (FIG. 2) with the coupled coefficient of friction potential μ, i.e. the reference value.

FIG. 2 shows the connection between different virtual wheel radii r and different coefficient of friction potentials μ on different roads in a box plot B1, B2, B3.

A box plot (also Box and Whisker Plot) is a diagram, which is used to graphically illustrate the distribution of a feature, here the virtual wheel radius r. A box plot consists of a rectangle and two lines, which extend this rectangle. The values lying outside the box are illustrated by means of the lines. So-called outliers lie above and below these lines. The dash in the box generally represents the median M of the distribution.

At the beginning of the box (from the bottom), the smallest 25% of the data values are less than or equal to this characteristic value. In the case of the median M, the smallest 50% of the data values are less than or equal to this characteristic value, and at the end of the box (above the median M), the smallest 75% of the data values are less than or equal to this characteristic value.

The virtual wheel radius r is thereby the quotient of vehicle longitudinal speed and wheel speed.

The first box plot B1 thereby specifies the distribution of the recorded virtual wheel radii r on a dry asphalted road.

The coefficient of friction potential is approx. μ=1.1 here.

The lower box end is at approx. 0.3431 m and the upper end at approx. 0.3435 m thereby (vehicle longitudinal speed/wheel speed).

When detecting a current virtual wheel radius r, which corresponds to a value within the box of the box plot B1, the autonomously operated motor vehicle 1 (FIG. 3) can thus for example assuming a coefficient of friction potential of approx. μ=1.1.

The second box plot B2 thereby specifies the distribution of the recorded wheel radii r on a wet molten basalt surface. The coefficient of friction potential μ is approx. 0.3 here.

The lower box end is thereby at approx. 0.3424 m and the upper end at approx. 0.3428 m. When detecting a current virtual wheel radius r, which corresponds to a value within the box of the box plot B2, the autonomously operated motor vehicle 1 (FIG. 3) can thus assume a coefficient of friction potential of approx. μ=0.3.

The third box plot B3 thereby specifies the distribution of the recorded wheel radii r on a wet polished granite surface.

The coefficient of friction potential is approx. μ=0.15 here.

The lower box end is thereby at approx. 0.3415 m and the upper end at approx. 0.3419 m. When detecting a current virtual wheel radius r, which corresponds to a value within the box of the box plot B3, the autonomously operated motor vehicle 1 (FIG. 3) can thus assume a coefficient of friction potential of approx. μ=0.15.

If the estimated coefficient of friction potential μ falls below a specified threshold value, a warning, for example, can also be generated, which prompts, for example, a driver to take over the steering wheel.

If an estimated coefficient of friction potential of only approx. μ=0.15 is present, such a warning can thus further be output to the driver.

FIG. 3 schematically shows a motor vehicle 1 in accordance with the present disclosure. The latter has an estimation device 2 for estimating a coefficient of friction potential μ between the wheels of a motor vehicle 1 and a surface of a roadway during an essentially unaccelerated drive of the motor vehicle 1.

The estimation device 2 thereby comprises at least one speed sensor 6 for detecting a wheel speed of at least one wheel of the motor vehicle 1.

The estimation device 2 further comprises a radar/Doppler radar 3 for detecting a highly accurate vehicle longitudinal speed of the motor vehicle 1 by means of the measured frequency change between a radar signal sent by the motor vehicle 1 and reflected radar signal received by the motor vehicle 1.

The estimation device 2 further comprises an evaluation unit 4, for example a processor, for determining the ratio between the detected vehicle longitudinal speed and the wheel speed as current virtual wheel radius r (FIG. 2). The evaluation unit 4 is further formed to compare the detected current virtual wheel radius r (FIG. 2) with at least one individual wheel radius r (FIG. 2) or a range of individual wheel radii r (FIG. 2), wherein the individual wheel radius r (FIG. 2) or the range of individual wheel radii r is coupled at least to the coefficient of friction potential μ for the current tires on an asphalted dry road. The individual wheel radius r (FIG. 2) or the range of individual wheel radii r is thereby preferably recorded by the driver himself.

Alternatively or additionally, the estimation device 2 comprises a database 5, in which at least one wheel radius r (FIG. 2) or a range of stored wheel radii r (FIG. 2) is stored, wherein the wheel radius r (FIG. 2) or the range of stored wheel radii r (FIG. 2) is coupled at least to the coefficient of friction potential μ for standard tires and/or the tire type of a respective vehicle type on an asphalted dry road. A database 5 can further also be provided, in which at least several wheel radii r are provided, which are coupled to the coefficient of friction potential μ for standard tires and/or the tire type of a respective vehicle type on different road surfaces, and by means of which the current coefficient of friction potential μ can be estimated by means of a comparison with the detected current virtual wheel radius r (FIG. 2).

Such a database 5 can be firmly preinstalled, for example by the vehicle manufacturer, depending on the vehicle type.

This sentence marks the end of the aforementioned section that may be considered distinct from or as complementing preceding disclosure. The remainder of this specification may be read as complementing any preceding disclosure.

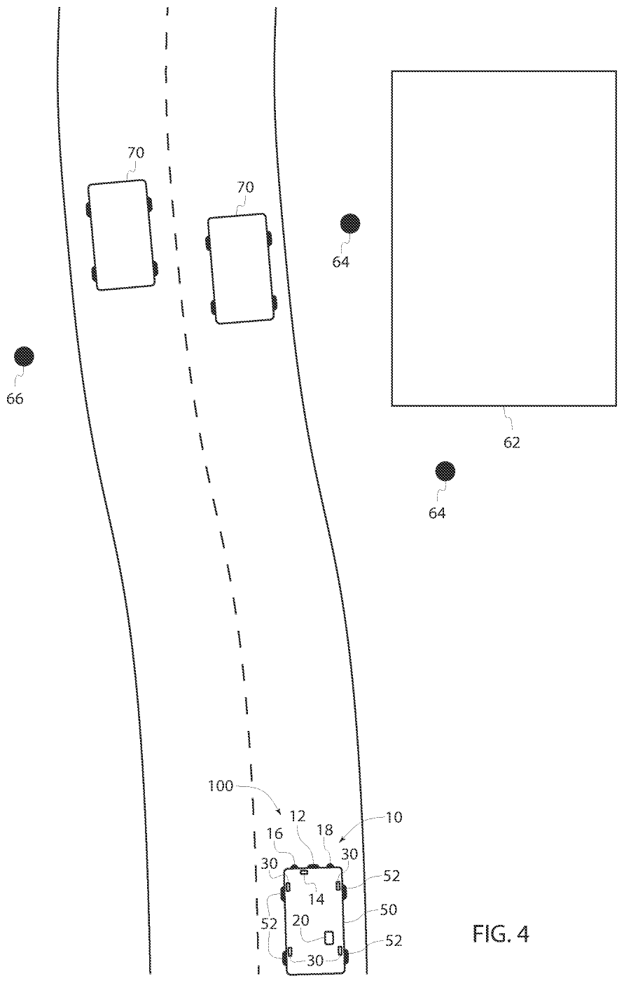

FIG. 4 schematically shows a system 100 in accordance with the present disclosure, e.g. as disclosed above.

In the embodiment of FIG. 4, system 100 comprises a measurement system 10, a data processing system 20, and four rotational speed sensors 30. Measurement system 10 comprises a (Doppler) radar 12, a processor 14, a camera 16, and a laser 18. System 100 is mounted onboard a vehicle 50 that comprises four wheels 52. Vehicle 50 is shown in an ambient environment comprising a building 62, trees 64, a lamppost 66, and moving cars 70. Each of rotational speed sensors 30 is individually structured to measure a rotational speed of a respective individual wheel 52. Measurement system 10 is structured to measure a longitudinal acceleration and a longitudinal speed of vehicle 50 relative to a plurality of ambient terrestrial objects. Such ambient terrestrial objects may comprise stationary objects such as building 62, trees 64, and lamppost 66.

In the present disclosure, the verb “may” is used to designate optionality/noncompulsoriness. In other words, something that “may” can, but need not. In the present disclosure, the verb “comprise” may be understood in the sense of including. Accordingly, the verb “comprise” does not exclude the presence of other elements/actions. In the present disclosure, relational terms such as “first,” “second,” “top,” “bottom” and the like may be used solely to distinguish one entity or action from another entity or action without necessarily requiring or implying any actual such relationship or order between such entities or actions.

In the present disclosure, the term “any” may be understood as designating any number of the respective elements, e.g. as designating one, at least one, at least two, each or all of the respective elements. Similarly, the term “any” may be understood as designating any collection(s) of the respective elements, e.g. as designating one or more collections of the respective elements, wherein a (respective) collection may comprise one, at least one, at least two, each or all of the respective elements. The respective collections need not comprise the same number of elements.

In the present disclosure, the expression “at least one” is used to designate any (integer) number or range of (integer) numbers (that is technically reasonable in the given context). As such, the expression “at least one” may, inter alia, be understood as one, two, three, four, five, ten, fifteen, twenty or one hundred. Similarly, the expression “at least one” may, inter alia, be understood as “one or more,” “two or more” or “five or more.”

In the present disclosure, expressions in parentheses may be understood as being optional. As used in the present disclosure, quotation marks may emphasize that the expression in quotation marks may also be understood in a figurative sense. As used in the present disclosure, quotation marks may identify a particular expression under discussion.

In the present disclosure, many features are described as being optional, e.g. through the use of the verb “may” or the use of parentheses. For the sake of brevity and legibility, the present disclosure does not explicitly recite each and every combination and/or permutation that may be obtained by choosing from the set of optional features. However, the present disclosure is to be interpreted as explicitly disclosing all such combinations/permutations. For example, a system described as having three optional features may be embodied in seven different ways, namely with just one of the three possible features, with any two of the three possible features or with all three of the three possible features.

While various embodiments of the present invention have been disclosed and described in detail herein, it will be apparent to those skilled in the art that various changes may be made to the configuration, operation and form of the invention without departing from the spirit and scope thereof. In particular, it is noted that the respective features of the invention, even those disclosed solely in combination with other features of the invention, may be combined in any configuration excepting those readily apparent to the person skilled in the art as nonsensical. Likewise, use of the singular and plural is solely for the sake of illustration and is not to be interpreted as limiting. Except where the contrary is explicitly noted, the plural may be replaced by the singular and vice-versa.

The above disclosure may be summarized as comprising the following embodiments:

### Embodiment 1

A method for estimating a coefficient of friction potential (ii) between wheels of a motor vehicle (1) and a surface of a roadway during an essentially unaccelerated drive of the motor vehicle (1), comprising the steps of:
detecting a wheel speed of at least one wheel of the motor vehicle (1) by means of a speed sensor (6),
detecting a highly accurate vehicle longitudinal speed of the motor vehicle (1),
determining the ratio between the detected vehicle longitudinal speed and the wheel speed as current virtual wheel radius (r),
estimating the current coefficient of friction potential (ii) by means of the current virtual wheel radius (r).

### Embodiment 2

The method according to Embodiment 1, wherein several virtual wheel radii (r) are measured within a predefined time, wherein the current virtual wheel radius (r) is determined as average value or median from the virtual wheel radii (r) and/or the most frequently occurring value as current virtual wheel radius (r) and/or the lowest value as current virtual wheel radius (r).

### Embodiment 3

The method according to Embodiment 1 or 2, wherein the vehicle longitudinal speed is determined by means of a measured frequency change between a reflected signal, which is sent by the motor vehicle (1) and received by the motor vehicle (1).

### Embodiment 4

The method according to Embodiment 3, wherein the signal is generated by means of a radar arranged on the motor vehicle (1) and/or of an arranged Doppler radar (3).

The method according to any one of Embodiments 1-4, wherein the vehicle longitudinal speed is determined by means of a DGPS signal (Differential Global Positioning System) received by the motor vehicle (1).

### Embodiment 6

The method according to any one of Embodiments 1-5, wherein the vehicle longitudinal speed is determined by means of a highly precise optical laser arranged on the motor vehicle (1).

### Embodiment 7

The method according to any one of Embodiments 1-6, wherein the detected current virtual wheel radius (r) is compared with at least one individual wheel radius (r) or a range of individual wheel radii (r), wherein the individual wheel radius (r) or the range of the individual wheel radii (r) is coupled at least to the coefficient of friction potential (μ) for the current tires on an asphalted road.

### Embodiment 8

The method according to Embodiment 7, wherein the individual wheel radius (r) or the range of individual wheel radii (r) is recorded manually by a driver in the case of an asphalted road.

### Embodiment 9

The method according to any one of Embodiments 1-8, wherein the detected current virtual wheel radius (r) is compared with at least one stored wheel radius (r) or a range of stored wheel radii (r), wherein the stored wheel radius (r) or the range of the stored wheel radii (r) is coupled at least to the coefficient of friction potential (μ) for standard tires and/or a tire type for the vehicle type on an asphalted road.

An estimation device (2) for estimating a coefficient of friction potential (μ) between the wheels of a motor vehicle (1) and a surface of a roadway during an essentially unaccelerated drive of the motor vehicle (1), the estimation device (2) comprising at least one speed sensor (6) for detecting a wheel speed of at least one wheel of the motor vehicle (1), wherein
a sensor system for detecting a highly accurate vehicle longitudinal speed of the motor vehicle (1) is provided as well as an evaluation unit (4) for determining the ratio between the detected vehicle longitudinal speed and the wheel speed as current virtual wheel radius (r) and for estimating the current coefficient of friction potential (IA) by means of the current virtual wheel radius (r).

### Embodiment 11

The estimation device (2) according to Embodiment 10, wherein the sensor system comprises at least one radar and/or Doppler radar (3), which is arranged on the motor vehicle (1), for measuring the vehicle longitudinal speed by means of a measured frequency change between a reflected signal sent by the radar and/or the Doppler radar (3) and received by the motor vehicle (1).

### Embodiment 12

The estimation device (2) according to Embodiment 10 or 11, wherein the evaluation unit (4) is formed to compare the detected current virtual radius (r) with at least one individual wheel radius (r) or a range of individual wheel radii (r), wherein the individual wheel radius (r) or the range of the individual wheel radii (r) is coupled at least to the coefficient of friction potential (IA) for the current tires on an asphalted dry road.

### Embodiment 13

The estimation device (2) according to any one of Embodiments 10 to 12, wherein a database (5) is provided, comprising at least one wheel radius (r) or a range of stored wheel radii (r), which is coupled at least to the coefficient of friction potential (μ) for standard tires and/or the tire type of a respective vehicle type on an asphalted road, is stored, and by means of which the current coefficient of friction potential (μ) can be estimated by means of a comparison with the detected current virtual wheel radius (r).

### Embodiment 14

The estimation device (2) according to Embodiment 13, wherein a database (5) is provided, comprising at least several wheel radii (r), which are coupled to the coefficient of friction potential (μ) for standard tires and/or the tire type for the respective vehicle type on different road surfaces, and by means of which the current coefficient of friction potential (μ) can be estimated by means of a comparison with the detected current virtual wheel radius (r).

### Embodiment 15

A motor vehicle (1) comprising an estimation device (2) according to any one of Embodiments 10 to 14 and/or a method according to any one of Embodiments 1 to 9.

### LIST OF REFERENCE NUMERALS

1 motor vehicle
2 estimation device
3 (Doppler) radar
4 evaluation unit
5 database
6 speed sensor
10 measurement system
12 (Doppler) radar
14 processor
16 camera
18 laser
20 data processing system
30 rotational speed sensor
50 vehicle
52 wheel
62 building
64 tree
66 lamppost
70 moving cars
100 system
μ coefficient of friction potential
r wheel radius
M median

1. A method, comprising:
measuring a rotational speed of a wheel of a vehicle,
determining a longitudinal acceleration of said vehicle relative to a plurality of ambient terrestrial objects using a measurement system onboard said vehicle,
determining a longitudinal speed of said vehicle relative to said plurality of ambient terrestrial objects using said measurement system,
judging a slippage state of said vehicle using said longitudinal acceleration, and
if a result of said judging indicates said vehicle is in a low-slippage state, estimating a coefficient of traction using said rotational speed and said longitudinal speed, wherein
said measurement system is structured to radiate electromagnetic energy and to receive reflections of said electromagnetic energy reflected from said plurality of ambient terrestrial objects.

2. The method of claim 1, wherein:
said measurement system comprises at least one of a radar, a Doppler radar, and a laser that radiates said electromagnetic energy.

3. The method of claim 1, wherein:
said measurement system comprises a camera, and
said measurement system uses said camera to identify at least one individual object belonging to said plurality of ambient terrestrial objects.

4. The method of claim 1, wherein:
said judging requires said longitudinal acceleration to have a magnitude of less than 0.5 m/s² for said result to indicate said vehicle is in a low-slippage state.

5. The method of claim 1, comprising:
determining a transverse acceleration of said vehicle relative to said plurality of ambient terrestrial objects using said measurement system, and
determining a transverse speed of said vehicle relative to said plurality of ambient terrestrial objects using said measurement system, wherein
said judging uses at least one of said transverse acceleration and said transverse speed.

6. The method of claim 1, wherein:
determining a transverse acceleration of said vehicle relative to said plurality of ambient terrestrial objects using said measurement system, and
determining a transverse speed of said vehicle relative to said plurality of ambient terrestrial objects using said measurement system,
said judging requires each of said longitudinal acceleration and said transverse acceleration to have a magnitude of less than 0.5 m/s² for said result to indicate said vehicle is in a low-slippage state, and
said judging requires transverse speed to be less than 1% of said longitudinal speed for said result to indicate said vehicle is in a low-slippage state.

7. The method of claim 1, wherein:
said measurement system performs said determining of said longitudinal speed such that said longitudinal speed represents an actual longitudinal speed of said vehicle with an accuracy of ±0.05%.

8. A method, comprising:
determining a longitudinal acceleration of a vehicle relative to a plurality of ambient terrestrial objects,
determining a longitudinal speed of said vehicle relative to said plurality of ambient terrestrial objects,
judging a slippage state of said vehicle using at least said longitudinal acceleration of said vehicle,
performing, while a result of said judging indicates said vehicle is in a low-slippage state, a plurality of data acquisitions, each individual data acquisition comprising:
measuring a first rotational speed of a first wheel of said vehicle,
estimating a first virtual wheel radius using said first rotational speed and said longitudinal speed, and
adding said first virtual wheel radius to a data pool as virtual wheel radius data, and
estimating a coefficient of traction using said virtual wheel radius data of said data pool.

9. The method of claim 8, wherein:
said determining of said longitudinal acceleration and said determining of said longitudinal speed are performed using a measurement system onboard said vehicle,
said measurement system is structured to radiate electromagnetic energy and to receive reflections of said electromagnetic energy reflected from said plurality of ambient terrestrial objects.

10. The method of claim 8, wherein each individual data acquisition comprises:
measuring a second rotational speed of a second wheel of a vehicle
estimating a second virtual wheel radius using said second rotational speed and said longitudinal speed, and
adding said second virtual wheel radius to a data pool as virtual wheel radius data.

11. The method of claim 10, wherein each individual data acquisition comprises:
measuring a third rotational speed of a third wheel of a vehicle
estimating a third virtual wheel radius using said third rotational speed and said longitudinal speed,
adding said third virtual wheel radius to a data pool as virtual wheel radius data,
measuring a fourth rotational speed of a fourth wheel of a vehicle
estimating a fourth virtual wheel radius using said second rotational speed and said longitudinal speed, and
adding said fourth virtual wheel radius to a data pool as virtual wheel radius data.

12. The method of claim 8, wherein:
said plurality of data acquisitions comprises at least 200 data acquisitions, and
said performing of said plurality of data acquisitions is effected in a contiguous time period of less than one second in duration.

13. The method of claim 8, wherein:
said judging requires said longitudinal acceleration to have a magnitude of less than 0.5 m/s² for said result to indicate said vehicle is in a low-slippage state.

14. The method of claim 8, wherein:
said judging requires each of said longitudinal acceleration and said transverse acceleration to have a magnitude of less than 0.5 m/s² for said result to indicate said vehicle is in a low-slippage state.

15. A system, comprising:
a rotational speed sensor structured to measure a rotational speed of a wheel of a vehicle,
a measurement system structured to determine a longitudinal acceleration of said vehicle relative to a plurality of ambient terrestrial objects and to determine a longitudinal speed of said vehicle relative to said plurality of ambient terrestrial objects,
a data processing system structured to judge a slippage state of said vehicle using said longitudinal acceleration and, if a result of said judging indicates said vehicle is in a low-slippage state, estimates a coefficient of traction using said rotational speed and said longitudinal speed, wherein
said measurement system is mounted onboard said vehicle, and
said measurement system is structured to radiate electromagnetic energy and to receive reflections of said electromagnetic energy reflected from said plurality of ambient terrestrial objects.

16. The system of claim 15, wherein:
said measurement system comprises at least one of a radar, a Doppler radar, and a laser that radiates said electromagnetic energy.

17. The system of claim 15, wherein:
said measurement system comprises a camera, and
said measurement system is structured to use said camera to identify at least one individual object belonging to said plurality of ambient terrestrial objects.

18. The system of claim 15, wherein:
said judging requires said longitudinal acceleration to have a magnitude of less than 0.5 m/s² for said result to indicate said vehicle is in a low-slippage state.

19. The system of claim 15, wherein:
said judging requires each of said longitudinal acceleration and said transverse acceleration to have a magnitude of less than 0.5 m/s² for said result to indicate said vehicle is in a low-slippage state.

20. The system of claim 15, wherein:
said measurement system is structured to determine said longitudinal speed such that said longitudinal speed represents an actual longitudinal speed of said vehicle with an accuracy of ±0.05%.
